(19) United States
(12) Patent Application Publication
(10) Pub. No.: US 2019/0044116 A1
(43) Pub. Date: Feb. 7, 2019

(54) BATTERY BOX FOR A TRACTION BATTERY

(71) Applicant: Mahle International GmbH, Stuttgart (DE)

(72) Inventor: Thomas Schiehlen, Eislingen (DE)

(21) Appl. No.: 16/055,095

(22) Filed: Aug. 4, 2018

(30) Foreign Application Priority Data
Aug. 4, 2017 (DE) 10 2017 213 554.9

(51) Int. Cl. H01M 2/10; B60S 5/06; B60L 11/18; H01M 10/625; H01M 2/02

(52) U.S. Cl. CPC H01M 2/1083; B60S 5/06; B60L 11/1879; H01M 2/0262; H01M 2/0242; H01M 2/024; H01M 10/625

(57) ABSTRACT

A battery box for a traction battery of an electric or hybrid motor vehicle may include a plurality of bracing elements secured to an associated node element of a plurality of node elements on each side and arranged to define a lattice structure. The plurality of node elements and the plurality of bracing elements may each have a respective hollow profile. The plurality of bracing elements and the plurality of node elements may externally delimit at least one cube-shaped accommodation space. A battery module of a traction battery may be braceable and securable in the at least one cube-shaped accommodation space.

### CROSS-REFERENCE TO RELATED APPLICATIONS

This application claims priority to German Patent Application No. DE 10 2017 213 554.9, filed on Aug. 4, 2017, the contents of which are hereby incorporated by reference in its entirety.

### TECHNICAL FIELD

The invention relates to a battery box for a traction battery of an electric or hybrid motor vehicle.

### BACKGROUND

Installing a traction battery in an electric or hybrid motor vehicle presents a challenge because of its high dead weight and large dimensions. Typically, there is neither enough installation space nor a standard-compliant protective structure available in a vehicle to minimise the risk of intrusion in an accident, for example. Therefore, when the traction battery is fastened in the existing vehicle structure, labour-intensive, expensive measures and reduced installation space are to be expected.

Some concepts and solutions for installing a traction battery in a vehicle are known from the related art. For example, the traction battery may be mounted on the vehicle with a housing and then connected to an external cooling system and electrical cable. Such a solution requires substantial installation space, and the supporting structures of the vehicle are substantially doubled unnecessarily because of the traction battery and the housing. Another option is described in DE 10 2013 218 038 A1. Here, a battery box for the traction battery is suggested, in which individual battery cells of the traction battery are arranged. The individual battery cells are also connected externally to cooling system and an electrical cable. In this case, the individual components of the battery box must also be very sturdy and some must be heavy in order to be able to support the traction battery's dead weight.

### SUMMARY

The problem addressed by the invention is that of improving a species-related battery box in such manner that a traction battery can be installed in an electric or hybrid motor vehicle; the battery box is strengthened and the dead weight of the battery box is reduced. In addition, functional integration should also be improved by the integration of line routing elements for fluid circulation and electrical cable routing.

This problem is solved according to the invention with the subject matter of the independent claim(s). Advantageous embodiments form the subject matter of the dependent claim(s).

The present invention is based on the general idea to increase the strength and modularity of a species-related battery box for a traction battery for an electric or hybrid motor vehicle, and to lower the dead weight of the battery box at the same time. In this context, the battery box has a number of bracing elements, each of which is attached to a node element on each side, and together form a lattice structure. The bracing elements and the node elements are designed as hollow profiles. According to the invention, the battery box is constructed from a plurality of bracing elements and a plurality of node elements and defines the external limits of at least one cube-shaped accommodation space, wherein a battery module of the traction battery may be braced and thus also secured in the at least one cube-shaped accommodation space.

The hollow profiles of the bracing elements and the hollow profiles of the node elements serve to reduce the dead weight of the battery box significantly, and advantageously to increase the strength of the battery box. The battery box according to the invention enables the battery box to be installed in the existing vehicle structure with labour-intensive, expensive measures and has a reduced installation space requirement. The battery box according to the invention may further be used to reinforce an existing vehicle structure, which in turn may serve to reduce the dead weight of the existing vehicle structure advantageously.

The individual bracing elements and the individual node elements may be constructed differently from each other so that the battery box may be adapted to the weight and dimensions of the individual battery modules that are fastenable in the battery box and may differ from each other. The bracing elements and the node elements may also be constructed in such manner that a lateral bracing in the respective accommodation space of the battery module which may be secured in the battery box is possible. The node elements may be connected both to the vehicle structure that is to say the body-in-white and to a part of the vehicle structure that is to say the body-in-white. The node elements enable mounting of the multiple bracing elements for constructing the battery box. In order to connect the battery box to the vehicle structure, fastening elements may be provided on the respective node elements, via which the battery box may be secured detachably in non-positive or form-fitting manner or also non-detachably by material bonding on the vehicle structure that is to say the body-in-white.

The battery box according to the invention may have one accommodation space or multiple accommodation spaces for the individual battery modules to be secured in the battery box, wherein the respective accommodation spaces are preferably cube-shaped. The battery modules that may be secured in the accommodation spaces may then be positioned next to each other and/or on top of each other to save space and the battery box according to the invention may be adapted to the available installation space. Thus for example eight individual battery modules may form a battery box with a 2×2×2 or a 4×2×1 configuration. The minimum number of accommodation spaces in the battery box according to the invention is one. Advantageously, the individual node elements may be different from each other and depending on the configuration of the battery box two to six bracing elements may be secured to the individual node element preferably at an angle of 90° or 180° to each other. The bracing elements may also be of different lengths, in order to be able to construct cube-shaped accommodation spaces in the battery box. The individual accommodation spaces are advantageously separated from each other by the respective bracing elements and node elements, and consequently the respective battery modules that may be secured in the accommodation spaces are protected individually. The risk of intrusion may be reduced considerably thereby.

It is advantageously provided that the respective hollow profile has an outer wall which delimits an inner space of the respective hollow profile. Alternatively, the respective hollow profile may include the outer wall and an inner wall, wherein the outer inner space is located between the outer wall and the inner wall and the inner space inner space is delimited by the inner wall. The outer wall of the respective hollow profile may have a circular, oval, rectangular, U-shaped, L-shaped or T-shaped cross section. In the case of a hollow profile with an inner wall, said wall is preferably arranged in the outer wall in such manner that at least a region of the outer inner space has a uniform thickness. The cross section of the hollow profile may be adapted according to its intended use and the loads to which it will be exposed. In another particularly preferred design of the hollow profile, the outer wall of the hollow profile has a circular cross section and the inner wall is arranged concentrically with the outer wall.

In order to secure the respective bracing elements on the respective node elements, it is advantageously provided that the respective node element has a first connecting structure and the respective bracing element has a second connecting structure complementary to the first connecting structure. In this way, the bracing element is secured to the respective node element in form-fitting manner by the first connecting structure and the second connecting structure. The first connecting structure and the second connecting structure are designed to fit into each other and may have the form of a tongue-and-groove joint for example. In order to be able to secure still more bracing elements on the respective node element, the individual node element suitably has two to six of the first connecting structures for the respective second connecting structures of the bracing element. In the battery box with the cube-shaped accommodation spaces, the respective first connecting structures are suitably arranged at an angle of 90° or 180° with respect to each other. With such a configuration of the respective bracing elements and the respective node elements, the battery box can be assembled and disassembled quickly in modules. Both assembly and maintenance of the battery modules that are to be secured inside the battery box may be considerably simplified. The strength of the battery box is also increased thereby.

In order to increase the strength of the battery box further, it is advantageously provided that the respective bracing element is secured to the associated node element in bonded, force-fitting or form-fitting manner. The respective bracing element is preferably secured to the associated node element by welding or soldering or by mechanical pressing or by clamping or by bolting. If the bonding method is used, the fatigue strength of the battery box may be increased considerably. Alternatively, the respective bracing elements may also be secured on the associated node element by adhesion, so that besides the bonded connection it is also possible to provide galvanic separation of the individual bracing elements and the individual node elements and prevent corrosion at the site of the joint between the respective bracing element and the respective node element.

In a preferred further development of the battery box according to the invention, it is advantageously provided that at least one fluid line node is secured in the inner space of the respective node element, and at least one fluid line is secured in the inner space of the respective bracing element, wherein the respective fluid line node and the associated fluid line are in fluid communication with each other. The respective fluid line nodes and the associated fluid lines may be in fluid connection with an external cooling system, so that a coolant may be fed via the respective fluid line nodes and that associated fluid lines to the individual accommodation spaces and individual cooling devices of the battery modules that may be secured in the accommodation spaces. The fluid line nodes and the fluid lines are arranged inside the respective interior spaces of the node elements with the hollow profiles and the bracing elements with the hollow profiles, so that the battery box is of space-saving construction, and the fluid line nodes and fluid lines are also protected from mechanical damage. Assembly and maintenance of the battery module that is to be secured inside the accommodation space are also simplified considerably thereby.

For securing the respective fluid line nodes and the associated fluid lines to each other, it is advantageously provided that the respective fluid line node and the associated fluid line have complementary plug-in contours, by which the fluid line and fluid line node are secured to each other in form-fitting and fluid conducting manner. The complementary plug-in contours may have the form of a tongue-and-groove joint, for example. In order to prevent leaking of the coolant between the fluid line nodes and the fluid lines, they may also be sealed. Thus for example the circular fluid lines may be sealed by O-shaped gaskets. The fluid line node may suitably have two to six of the corresponding plug-in contours, so that multiple fluid lines may also be secured to the fluid line node. In the cube-shaped accommodation spaces, the plug-in contours on the fluid line node are arranged at an angle of 90° or 180° to each other. The complementary plug-in contours allow the battery box with the already integrated fluid line nodes and the already integrated fluid lines to be assembled quickly and with less effort.

It is further advantageously provided that the respective fluid line node and the associated fluid line are secured to each other in fluid-conducting and materially bonded manner, preferably by welding or soldering or by adhesive bonding or by mechanical pressing. When the associated fluid lines are secured to the respective fluid line node by material bonding, a fatigue strength of the battery box is advantageously increased. Leaking of the coolant may also be advantageously prevented.

In a further development of the battery box according to the invention, it is advantageously provided that at least one electrical wire node is secured in the inner space of the respective node element and at least one electrical wire is secured in the inner space of the respective bracing element. In this context, the respective electrical wire nodes and the associated electric wires are connected to each other for electrical conductivity in materially bonded and/or form-fitting and/or force-fitting manner. The electric wire may be secured to the electrical wire node in form-fitting manner by means of a plug and socket connector or the like, for example. Securing by material bonding may be assured for example by soldering or welding or adhesive bonding, and securing by force-fitting may be assured with a threaded connection. The arrangement of the electrical wire nodes in the node elements and the electrical wires in the bracing elements enables the battery box to be constructed quickly and without occupying excessive space. Moreover, the respective electric wires and the respective electrical wire nodes are advantageously protected from mechanical damage. By means of the respective electric wires and the respective electrical wire nodes, the individual battery modules that may be secured in the respective accommodation spaces may be electrically connected to each other and connected to the vehicle onboard battery high-voltage network with less labour.

In order to increase the strength of the battery box, it is further advantageously provided that the inner space or the outer inner space of the respective node element and/or the inner space or the outer inner space of the respective bracing element is/are filled with a structural filler material. In this case, it is provided that the structural filler material is made from a metallic or a resin-based or plastic-based foam, or alternatively from a metallic or a plastic-based packing material. The structural filler material may be applied beforehand, for example, when the battery box is assembled, and tempered to create a foam by heating. Thus, the structural filler material may fill out the respective inner spaces of the bracing elements and the node elements in the form of a spherical material for example, and then be expanded thermally to create a foam. The respective bracing elements and the respective node elements are strengthened by the structural filler material, so that the strength of the battery box is increased and a greater amount of energy can be absorbed, in the event of an accident, for example. Moreover, the dimensions of the respective bracing elements and of the respective node elements may be reduced without loss of strength, and the design of the battery box may be more compact. The fluid lines and the electric wires in the respective bracing elements and the fluid line nodes and electrical wire nodes in the respective node elements may also be secured advantageously and the connections between these elements may be prevented from becoming detached by means of the structural filler material.

It is advantageously provided that the respective node element and/or the respective bracing element is/are made from a metal or a plastic. Of the metals, steel or aluminium and in the case of plastics are fibre-reinforced plastic or polyamide are preferred. The fibre-reinforced plastic may be example a glass fibre-reinforced or carbon fibre-reinforced plastic. With such a construction of the bracing elements and node elements, the strength of the battery box may be increased considerably, and the dead weight of the battery box may also be reduced particularly when the bracing elements and node elements are made from a plastic.

In a further development of the node element, it is advantageously provided that the respective node element is manufactured in a casting process, preferably by injection moulding, or in a printing process. The printing process includes three-dimensional production techniques such as laser sintering, selective laser melting, or 3D printing. With such a production process of the node elements, many different forms can be created inexpensively and without excessive labour. It is further provided that the respective bracing element is manufactured with a rolling technique or by extrusion, which may also reduce manufacturing costs and manufacturing labour advantageously.

The battery box may advantageously include at least one battery module which is arranged in the at least one accommodation space. In order to protect the battery modules, it is advantageously provided that the battery box has a housing in which the lattice structure of the battery box is secured in form-fitting or force-fitting manner. The dead weight of the battery modules is then supported by the lattice structure, so that the housing may be made from a plastic, for example, and perform only a covering function. The housing may serve to protect the battery modules in the battery box from dirt. Further structures such as fluid and/or electrical and/or data transmitting connection points which enable the battery box to be connected to external components, such as an external cooling system for example, may also be arranged in the housing.

In the battery box according to the invention overall, the hollow profile bracing elements and node elements have the effect of considerably reducing the dead weight of the battery box and advantageously increasing the strength of the battery box. The battery box according to the invention may also be installed in the existing vehicle structure without expensive, labour-intensive measures, it occupies and may be connected in a compact installation space, and may further serve advantageously to strengthen the vehicle structure.

Further important features and advantages of the invention will be discerned from the subclaims, the drawings and the associated description of the figures with reference to the drawings.

Of course, the features described in the preceding text and those that will be explained subsequently are in each case usable not only in the combination described, but also in other combinations or alone without departing from the scope of the present invention.

Preferred embodiments of the invention are represented in the drawings and will be explained in greater detail in the following description, wherein the same signs denote identical or similar or functionally equivalent components.

### BRIEF DESCRIPTION OF THE DRAWINGS

In the schematic drawings

FIG. 1 shows a view of a battery box according to the invention;

FIG. 2 shows a cross sectional view of a connection point between a node element and a bracing element of a battery box according to the invention;

FIGS. 3 to 6 show cross sectional view of variously constructed hollow profiles;

FIG. 7 shows a view of a node element with a wire node and a fluid line node.

### DETAILED DESCRIPTION

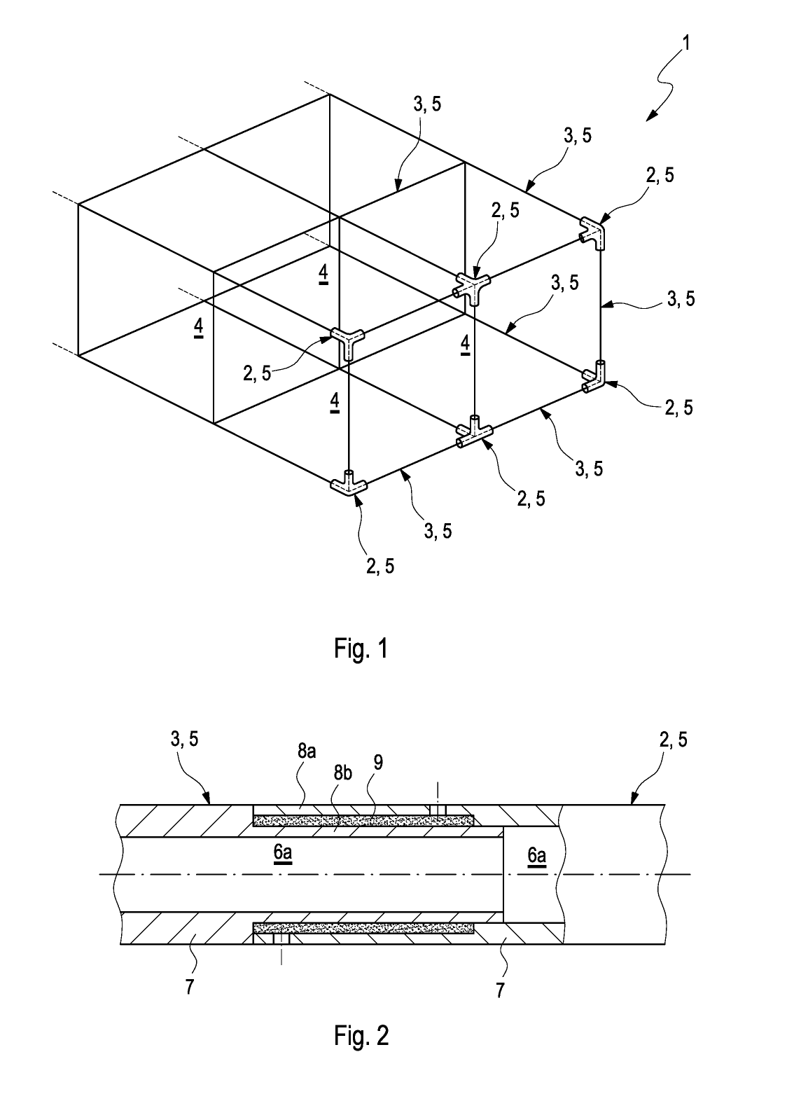

FIG. 1 shows a schematic view of a battery box 1 according to the invention having a plurality of node elements 2 and a plurality of bracing elements 3. The respective bracing elements 3 are each secured to one node element 2 on both sides and form a lattice structure with multiple accommodation spaces 4, each for one battery module not shown here. The respective bracing elements 3 and the respective node element 2 may be made from a metal or a plastic for example. In this embodiment, the battery box 1 has four accommodation spaces 4 and may be expanded to any size. The respective node elements 2 are of different construction and a different number of bracing elements 3 is secured to an individual node element 2. The node elements 2 and the bracing elements 3 are constructed in the form of hollow profiles 5. The construction of the node elements 2 and the bracing elements 3 in the form of hollow profiles 5 may serve to reduce the dead weight of the battery box 1 considerably, and advantageously increase the strength of the battery box 1.

FIG. 2 shows a partial cutaway view of a connection point between one of the node elements 2 and one of the bracing elements 3. The node element 2 and the bracing element 3 are each constructed in the form of hollow profile 5 with an inner space 6a, wherein the respective inner space 6a is delimited in each case by an outer wall 7 of the respective hollow profile 5. The node element 2 has a first connecting structure 8a and the bracing element 3 has a second connecting structure 8b that complements the first connecting structure 8a. The first connecting structure 8a and the second connecting structure 8b provide the means for securing the bracing element 3 to the node element 2 in form-fitting manner, wherein the inner space 6a of the node element 2 adjoins the inner space 6a of the bracing element 3. The first connecting structure 8a and the second connecting structure 8b are constructed to complement each other and in this embodiment have the form of a plug-in connection. Alternatively, a tongue-and-groove joint is also conceivable. In order to increase the strength of the battery box 1, the bracing element 3 is secured to the node element 2 additionally by material bonding in the form of an adhesive film 9.

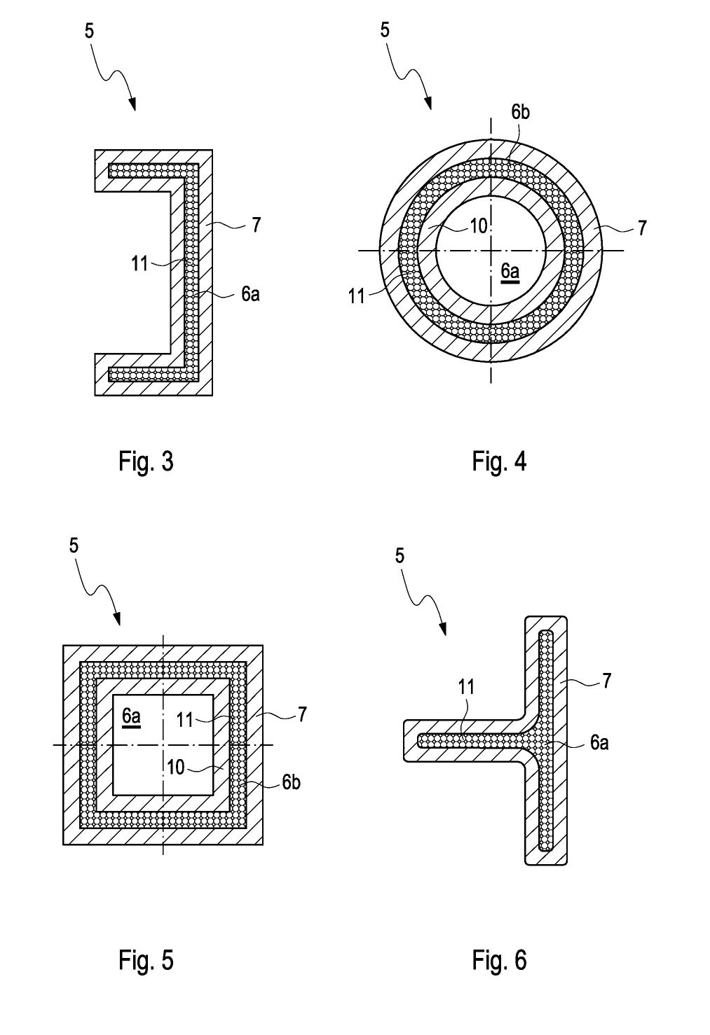

FIG. 3 to FIG. 6 show cross sectional views of the variously designed hollow profiles 5. In FIG. 3, the hollow profile 5 has a U-shaped cross section, and the inner space 6a of the hollow profile 5 is delimited by the outer wall 7. In FIG. 4, the hollow profile 5 has a circular cross section, wherein an outer inner space 6b in this embodiment is delimited by the outer wall 7 and an inner wall 10, and the inner space inner space 6a is delimited by the inner wall 10. The inner wall 10 is concentric with the outer wall 7, so that the outer inner space 6b has a uniform thickness. FIG. 5 shows the hollow profile 5 with a square cross section, in which the inner space 6b is located between the outer wall 7 and the inner wall 10 and the inner space 6a is delimited by the inner wall 10. Here, the outer wall 7 and the inner wall 10 are arranged in such manner that at least a region of the outer inner spaces 6b is of uniform thickness. In FIG. 6, the hollow profile 5 is shown with a T-shaped cross section, and the inner space 6a is delimited by the outer wall 7. In the designs shown here, the inner space 6a or the outer inner space 6b of the hollow profile 5 is filled with a structural filler material 11. The structural filler material 11 may be made for example from a metallic or a resin-based or plastic-based foam, or alternatively it may consist of a metal or plastic-based packing material. The structural filler material 11 has the effect of strengthening the respective node elements 2 and the respective bracing elements 3, so that the strength of the battery box 1 is increased and a greater quantity of energy can be absorbed in the event of an accident.

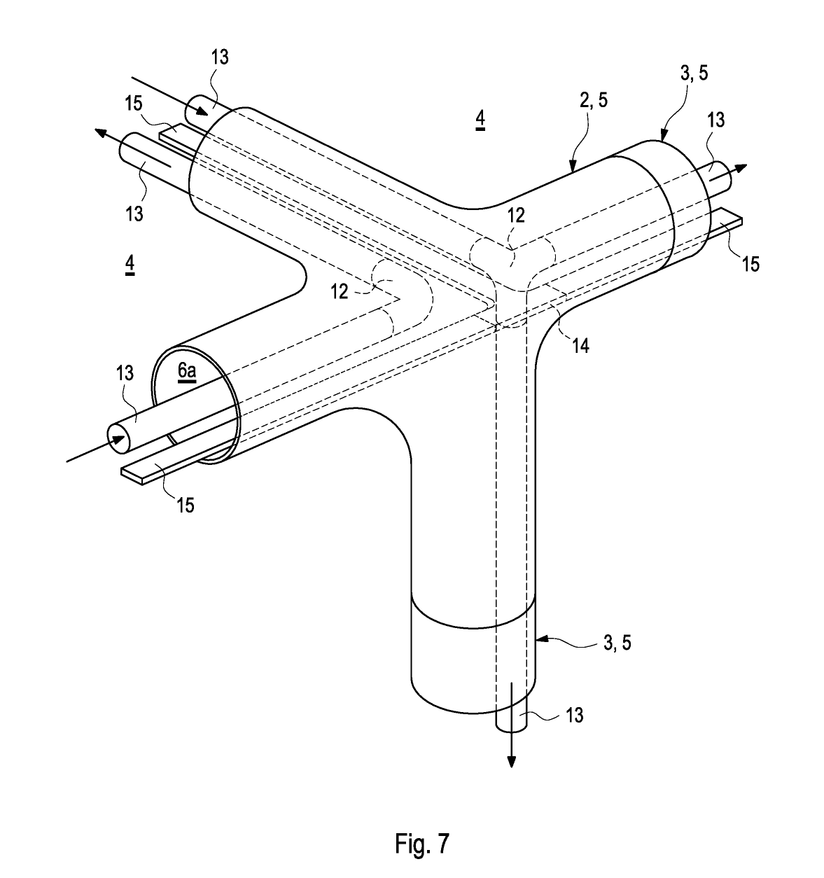

FIG. 7 shows a view of the node element 2 with the bracing elements 3. Two fluid line nodes 12 are arranged in the inner space 6a of the node element 2, and a plurality of fluid lines 13 of the bracing elements 3 are secured thereto. The fluid line node 12 and the fluid lines 13 are in fluid communication with each other and may transport a coolant supplied by an external cooling system to and from the individual accommodation spaces 4 and the individual cooling devices of the battery modules which may be secured in the accommodation spaces 4 through the battery box 1. The fluid line node 12 and the fluid lines 13 are arranged in the inner spaces 6a of the hollow profile node element 2 and the hollow profile bracing element 3, lending the battery box 1 a space-saving construction. The fluid line nodes 12 and the fluid lines 13 are also protected from mechanical damage by the node element 2 and the bracing elements 3.

In addition, an electrical wire node 14 is arranged in the inner space 6a of the node element 2 and electric wires 15 are arranged in the individual inner spaces 6a of bracing elements 3. In this context, the electric wires 15 and the electrical wire node 14 are connected to each other in electrically conductive manner by form-fitting means, for example by a plug and socket connection. The arrangement of the electrical wire node 14 and the electric wires 15 in the inner spaces 6a of the node element 2 and the bracing elements 3 enable the battery box 1 to be assembled quickly while occupying little space, and the electrical wire node 14 and electric wires 12 to be protected from mechanical damage. The individual battery modules which can be secured in the respective accommodation spaces 4 may thus be connected to each other electrically and connected to the vehicle onboard battery high-voltage network.

Overall, the hollow profile node elements 2 and the hollow profile bracing elements 3 in the battery box 1 according to the invention have the effect of considerably reducing the dead weight of the battery box 1 and advantageously increasing the strength of the battery box 1. The battery box 1 according to the invention may also be installed in the existing vehicle structure without expensive, labour-intensive measures, and it may also serve advantageously to strengthen the vehicle structure.

1. A battery box for a traction battery of an electric or hybrid motor vehicle, comprising:
a plurality of bracing elements secured to an associated node element of a plurality of node elements on each side and arranged to define a lattice structure;
the plurality of node elements and the plurality of bracing elements each having a respective hollow profile; and
the plurality of bracing elements and the plurality of node elements externally delimiting at least one cube-shaped accommodation space, wherein a battery module of a traction battery is braceable and securable in the at least one cube-shaped accommodation space.

2. The battery box according to claim 1, wherein at least one of:
the respective hollow profile includes an outer wall delimiting an inner space of the respective hollow profile; and
the respective hollow profile includes the outer wall and an inner wall, wherein an outer inner space is defined between the outer wall and the inner wall, and the inner space is delimited by the inner wall.

3. The battery box according to claim 1, wherein each of the plurality of node elements include a first connecting structure and each of the plurality of bracing elements includes a second connecting structure complementing the first connecting structure, wherein the plurality of bracing elements are secured to the associated node element in form-fitting manner via the first connecting structure and the second connecting structure.

4. The battery box according to claim 1, wherein the plurality of bracing elements are secured to the associated node element in at least one of a materially bonded manner, a force-fitting manner, and a form-fitting manner.

5. The battery box according to claim 2, further comprising at least one fluid line node arranged in the inner space of a respective node element of the plurality of node elements and at least one fluid line arranged in the inner space of a respective bracing element of the plurality of bracing elements, wherein the at least one fluid line node and the at least one fluid line are secured to and in fluid communication with each other.

6. The battery box according to claim 5, wherein the at least one fluid line node and the at least one fluid line have complementary plug-in contours, via which the at least one fluid line node and the at least one fluid line are connected to each other in a form-fitting manner and a fluid-conducting manner.

7. The battery box according to claim 5, wherein the at least one fluid line node and the at least one fluid line are secured to each other in a fluid-conducting and materially bonded manner.

8. The battery box according to claim 2, further comprising at least one electrical wire node arranged in the inner space of a respective node element of the plurality of node elements and at least one electric wire in the inner space of a respective bracing element of the plurality of bracing elements, wherein the at least one electrical wire node and the at least one electric wire are connected to each other electrically conductively and in at least one of a materially bonded manner, a form-fitting manner, and a force-fitting manner.

9. The battery box according to claim 2, wherein at least one of:
one of the inner space and the outer inner space of the plurality of node elements are filled with a structural filler material; and
one of the inner space and the outer inner space of the plurality of bracing elements are filled with the structural filler material.

10. The battery box according to claim 9, wherein the structural filler material includes at least one of a metallic foam, a resin-based foam, and a plastic-based foam.

11. The battery box according to claim 9, wherein the structural filler material includes at least one of a metallic packing material and a plastic-based packing material.

12. The battery box according to claim 1, wherein at least one of i) the plurality of node elements and ii) the plurality of bracing elements are composed of at least one of a metal and a plastic.

13. The battery box according to claim 1, wherein the plurality of node elements include a plurality of casted node elements.

14. The battery box according to claim 1, wherein the plurality of bracing elements include at least one of i) a plurality of rolled bracing elements and ii) a plurality of extruded bracing elements.

15. The battery box according to claim 1, further comprising at least one battery module arranged in the at least one cube-shaped accommodation space.

16. The battery box according to claim 1, further comprising a housing in which the lattice structure is secured in one of a form-fitting manner and a force-fitting manner.

17. The battery box according to claim 4, wherein the plurality of bracing elements are secured to the associated node element via at least one of a welding connection, a soldering connection, an adhesive bonding connection, a mechanical pressing connection, a clamping connection, and a bolt connection.

18. The battery box according to claim 12, wherein at least one of i) the plurality of node elements and ii) the plurality of bracing elements are composed of at least one of steel, aluminum, fibre reinforced plastic, and a polyamide

19. A battery box comprising:
a plurality of bracing elements secured to an associated node element of a plurality of node elements on each side, the plurality of bracing elements and the plurality of node elements structured and arranged to define a lattice structure and delimit at least one cube-shaped accommodation space, the at least one cube-shaped accommodation space configured such that a battery module of a traction battery is braceable and securable therein;
each of the plurality of node elements including a first connecting structure and each of the plurality of bracing elements inducing a second connecting structure complementing the first connecting structure, the plurality of bracing elements secured to the associated node element in form-fitting manner via the first connecting structure and the second connecting structure.
the plurality of node elements and the plurality of bracing elements each having a respective hollow profile;
wherein at least one of:
the respective hollow profile includes an outer wall delimiting the inner space of the respective hollow profile; and
the respective hollow profile includes the outer wall and an inner wall, an outer inner space defined between the outer wall and the inner wall, and the inner space delimited by the inner wall;
wherein at least one fluid line node is arranged in an inner space of a respective node element of the plurality of node elements and at least one fluid line is arranged in an inner space of a respective bracing element of the plurality of bracing elements, the at least one fluid line node and the at least one fluid line secured to and in fluid communication with each other.

20. A battery box comprising:
a plurality of bracing elements secured to an associated node element of a plurality of node elements on each side, the plurality of node elements and the plurality of bracing elements each having a respective hollow profile, the plurality of bracing elements and the plurality of node elements structured and arranged to define a lattice structure and delimit at least one cube-shaped accommodation space, the at least one cube-shaped accommodation space configured such that a battery module of a traction battery is braceable and securable therein;
a housing in which the lattice structure is secured in one of a form-fitting manner and a force-fitting manner; and
at least one battery module arranged in the at least one cube-shaped accommodation space.
